(19) United States
(12) Patent Application Publication
(10) Pub. No.: US 2004/0221147 A1
(43) Pub. Date: Nov. 4, 2004

(54) Method for updating BIOS

(76) Inventors: Wei-Wen Tseng, Taipei (TW); Chin-Yu Wang, Taipei (TW); Ching-Yu Cheng, Taipei (TW)

Correspondence Address: RABIN & Berdo, PC, 1101 14TH STREET, NW, SUITE 500, WASHINGTON, DC, 20005, US

(21) Appl. No.: 10/834,259

(22) Filed: Apr. 29, 2004

(30) Foreign Application Priority Data
Apr. 29, 2003 (TW) 92110076

(51) Int. Cl. G06F 15/177

(52) U.S. Cl. 713/1

(57) ABSTRACT

A method for updating or recovering a BIOS setting. The procedure for updating BIOS recovery and upgrade are accomplished by a BIOS update program along with a data file. By executing the BIOS update program, hardware information comprised in the data file is decompressed to obtain the flash memory format, and a BIOS image file comprised in the data file is then written to the flash memory accordingly.

### BACKGROUND OF THE INVENTION

1. Field of the Invention

The present invention relates to a method for updating BIOS, and in particular to a method for updating or recovering the BIOS by a BIOS update program stored in peripheral storage devices.

2. Description of the Related Art

Currently, conventional computer architecture, as shown in FIG. 1, comprises a central processing unit (CPU) 11. The CPU 11 is connected to a first chip 12 by a first bus 101. The first bus is a front-side bus (FSB). The first chip 12 is referred to as Northbridge, and the second bus 102, connected to the system memory 13 is currently implemented at 64-bit Double Data Rate (DDR). The first chip 12 is also connected to the second chip 14 by a third bus 103. The second chip 14 is referred to as Southbridge connecting other peripheral storage devices 15 such as CD-ROM and hard disk drive. Custom configuration files are stored in the CMOS memory 140 in the second chip 14, while the basic input output system (BIOS) is stored as a BIOS image file in a memory block 160 within a flash memory 16. All components described above, including CPU 11, system chip 12 & 14, BIOS, CMOS memory 140, Flash memory 16 are known in the art and detailed descriptions are thus omitted.

If current BIOS is assessed as erroneous during boot, or when boot fails, recovery is undertaken through a BIOS updating procedure. As shown in FIG. 2A, the peripheral storage device 15 corresponding to FIG. 1 can be a compact disc drive, floppy disk drive, hard disk drive, or other peripheral storage device, storing data required for updating. The stored data may include a BIOS image file, BIOS update program, and bootable OS (Operating System). When boot fails, the computer system boots according to an OS provided from the peripheral storage device 15, and the BIOS in the flash memory 16 is then recovered or updated by the BIOS image file in the peripheral storage device 15. The BIOS image file, for example, can be a binary file (*.bin). The BIOS image file, the BIOS update program, and corresponding hardware format information of the flash memory generally are provided by product vendors.

FIG. 2A to FIG. 2D show conventional a BIOS update procedure. As shown in FIG. 2A, the peripheral storage device 15 is partitioned into several memory blocks. The first block 151 may store an OS, the second block 152 a BIOS update program (ie: flash.exe) and the third block 153 a BIOS image file.

The computer system boots with the embedded OS from the peripheral storage devices 15. The embedded OS is first loaded into the first block 131 of system memory 13, and the BIOS update program in the second storage block 152 of the peripheral storage device 15 is then executed to load hardware data in the BIOS update program into the second memory block 132 of the system memory 13. The hardware data comprises specific information of formats and erase and write function of different kinds of flash memories.

FIG. 2B shows the executed BIOS update program conducts detection for the format of the flash memory 16. If the format of the flash memory 16 is found to be compatible basing upon the content of the hardware data, erase and write function can then be accordingly determined for further procedure.

Thereafter, as shown in FIG. 2C, the BIOS image file is then loaded from the peripheral storage device 15 into the third memory block 133 of the system memory 13, ready for storing in the flash memory 16.

As shown in FIG. 2D, the flash memory 16 is then formatted by the BIOS update program, resulting in erasure of all data stored in the flash memory 16. The BIOS image file is then transferred from system memory 13 into the formatted flash memory 16 and the BIOS updating procedure is complete.

FIG. 2E is a flowchart of conventional BIOS updating procedure. In step S21, after the computer system is booted with an OS embedded in a peripheral storage device, the embedded OS and the BIOS update program are then loaded into the system memory, as shown in step S22. In step S23, the format of the flash memory is detected. If the format of the flash memory is compatible according to the hardware information in the BIOS update program, step S24 commences, and if not, the BIOS updating procedure is terminated.

In step S24, the BIOS image file is then loaded from the peripheral storage device into the system memory. The BIOS update program erases or clears the original data in the flash memory, as shown in step S25. In the final step 26, the BIOS image file is then written from the peripheral storage device, through the system memory and into the flash memory.

The disadvantages of conventional BIOS updating procedure include that the BIOS update program need not only the executive program but also the hardware information of various kinds of flashes. As long as motherboard manufacture creates different advanced motherboards, the hardware information needs to be expanded to include the information of new version flashes. Incorporating the hardware information into the BIOS update program complicates the way to build a new BIOS update program for next generation motherboard.

### SUMMARY OF THE INVENTION

The object of this invention is to avoid the complex way for generating a new BIOS update program.

The present invention is directed to provide a method for recovering or updating the BIOS setting of a computer system with a BIOS update program stored in a peripheral storage device. Controlled by the BIOS update program, a data file is decompressed and temporarily stored in the system memory, and information of flash memory format is obtained by reading hardware information comprised in the decompressed data. According to the information read, the BIOS is updated by writing the BIOS image file into the flash memory.

The updating method according the present invention comprises the following steps. First, an OS is loaded to a computer system memory block. A data file is then decompressed to the system memory, such that information of flash memory format is obtained therefrom. This data file also comprises erase functions and write functions supporting different flash memory formats, and a BIOS image file. After decompressing the data file, original or out-of-date data in the flash memory is erased by the corresponding erase function. When the flash memory format is determined to be compatible with the BIOS image file, the BIOS image file in the system memory is then written to the flash memory.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 shows conventional computer architecture.

FIGS. 2A to 2E show conventional BIOS upgrade according to FIG. 1.

FIGS. 3A to 3E show a method for updating BIOS according to the present invention.

FIG. 4 is a flowchart of BIOS updating according to the present invention.

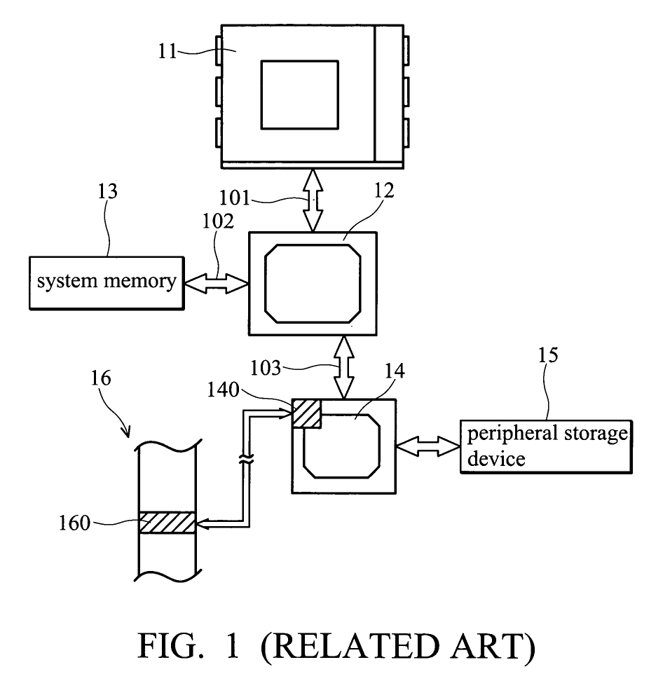

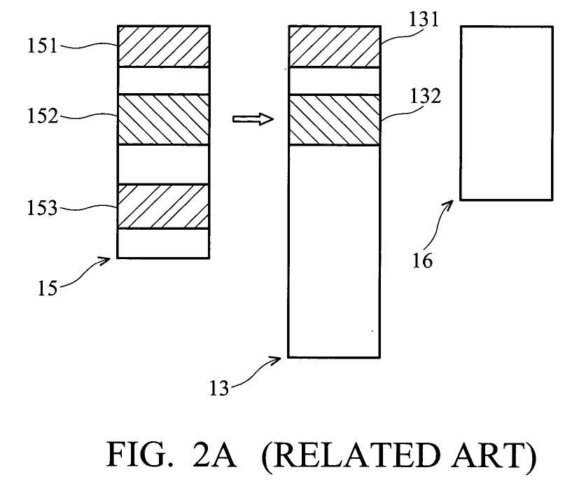

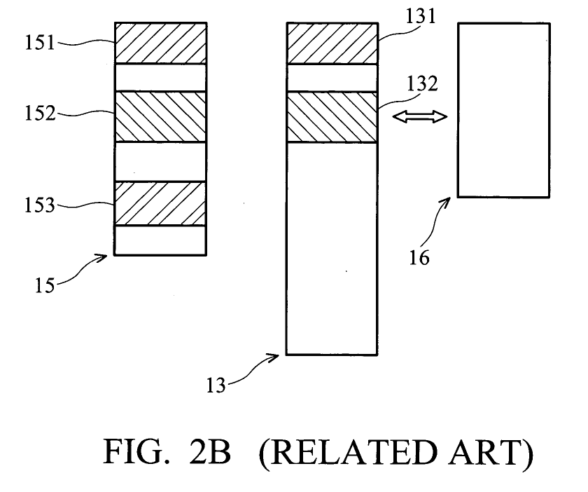

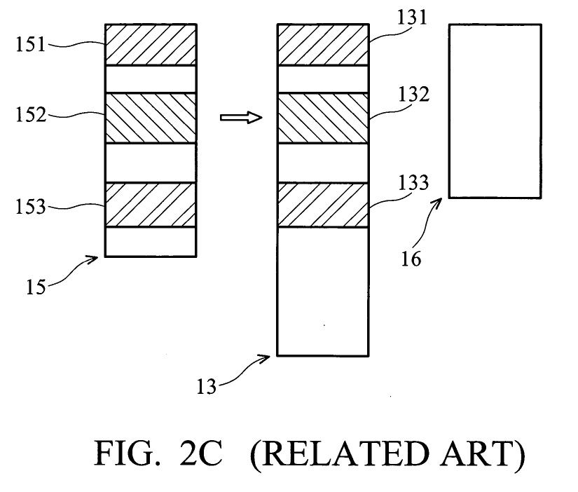

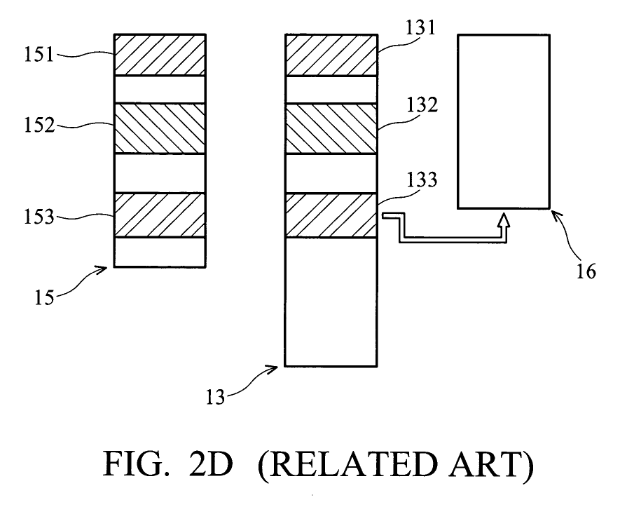

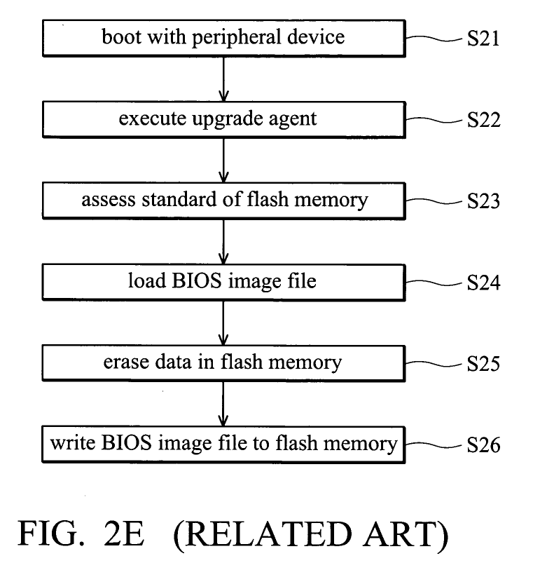

### DETAILED DESCRIPTION OF THE INVENTION

The method of the present invention utilizes only a small size BIOS update program for updating the BIOS in a flash memory. Unlike a conventional BIOS update program, which includes hardware information, the BIOS update program of the present invention excludes hardware information. Nevertheless, the hardware information of different kinds of flash memories is put in a compressed data file that include the hardware information and a BIOS image file. The hardware information includes memory addresses, erase and write functions and flash memory formats of different kind flash memories. After decompressing the compressed data file, memory addresses and flash memory format can be obtained therefrom and the decompressed BIOS image file can be written into the flash/BIOS memory accordingly.

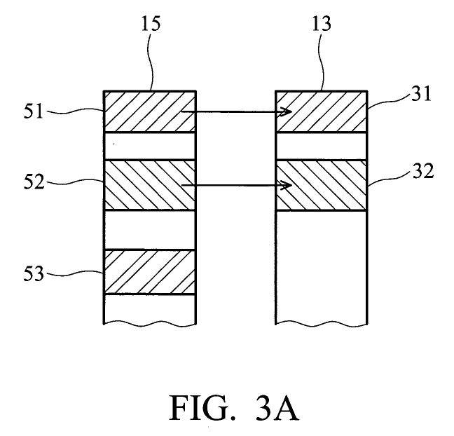

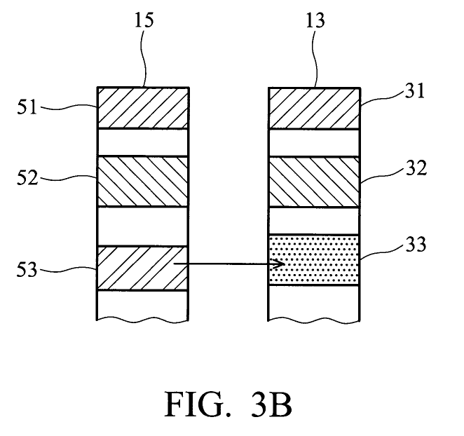

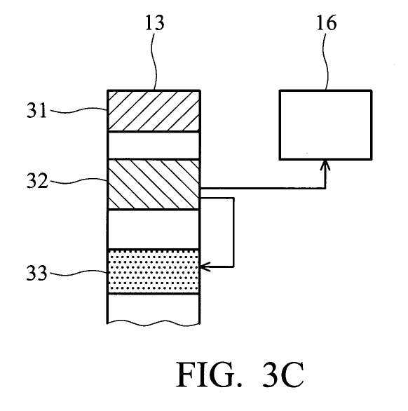

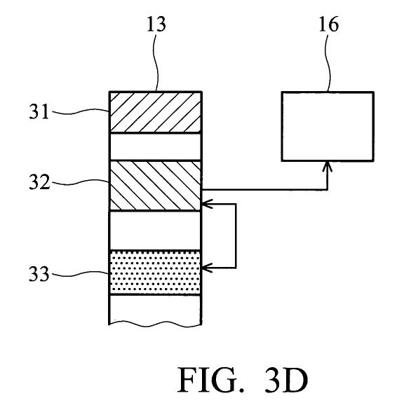

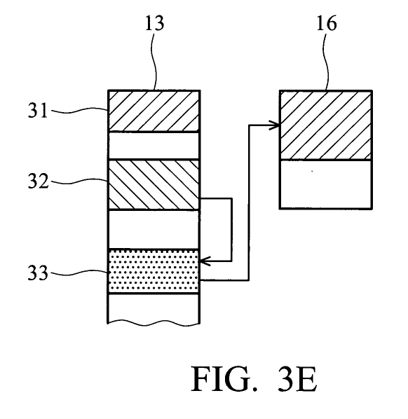

One embodiment shown in FIG. 3A to FIG. 3E, a peripheral storage device 15 provides at least one boot function. The system memory 13, usually being dynamic random access memory (DRAM), is for storing data and programs required for the processor. A flash memory 16 is provided for storing a BIOS image file.

As shown in FIG. 3A, the peripheral storage device 15 is partitioned into several memory blocks. The first block 51 contains an OS. A BIOS update program of the present invention is stored in the second memory block 52. A compressed data file having compress hardware information and a compressed BIOS image file is stored in the third block 53.

When a computer can not boot by reading the original BIOS image file in the flash memory 16, the computer boots with an OS stored in the peripheral storage device 15. The OS and the BIOS update program need not necessarily be in the same peripheral device 15, and can be accessed from different storage media. After booting, the OS is then loaded into a first memory block 31 of the system memory 13. Thereafter, a BIOS update program stored in the peripheral storage device 15 is loaded into a second memory block 32.

As shown in FIG. 3B, by executing the BIOS update program, the compressed data file in the peripheral storage device is decompressed and written to the third memory block 33 of the system memory 13. The decompressed data in the third memory block 33 comprises the BIOS image file and hardware information including flash memory format and functions corresponding to various standards of flash memory 16. Since the BIOS image file and hardware information are both in the same file, they are written into the system memory 13 at the same time, or at the same step.

As shown in FIG. 3C, controlled by the BIOS update program stored in the second memory block 32, the format of the flash memory 16 are obtained accordingly and is checked whether it has been listed in the decompressed hardware information.

If the format of the flash memory 16 is included in the decompressed hardware information, it means that the hardware information also lists functions of the flash memory 16 and the BIOS update program can control the flash memory 16 accordingly. As shown in FIG. 3D, by reading the erasing function in the hardware information, the BIOS update program conducts to erase or clear the original BIOS image file in the flash memory 16.

As shown in FIG. 3E, a BIOS image file within the decompressed data is copied from the system memory 13 into the flash memory 16 to finalize the BIOS updating procedure of the present invention.

Additionally, the computer can connect to a website that provides BIOS update programs (ie: *.bin) and/or compressed data files.

Thus compressed file can be available by accessing backup disks attached to the peripheral storage device 15. Additionally, the compressed file comprises compressed information of flash memory format, corresponding routine functions and a BIOS image file.

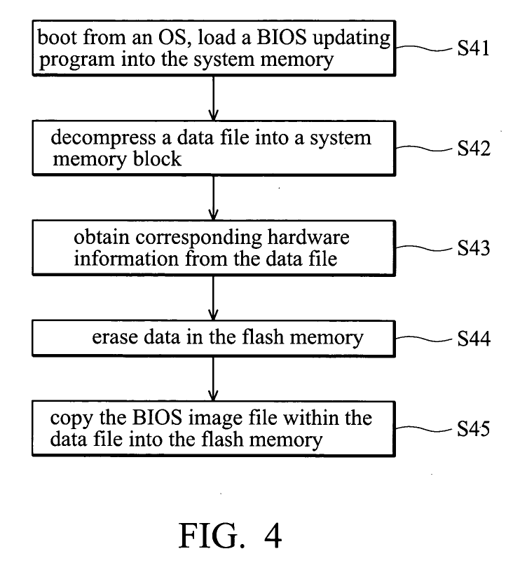

FIG. 4 is a flowchart showing BIOS update program according to the present invention. First, an OS is loaded from a peripheral device, and a program is then executed to load a BIOS update program into the system memory, as shown in step S41. Thereafter, a memory block within the system memory is allocated for decompressing a compressed data file, as shown in step S42. The compressed data file decompressed, generally supplied by vendors, is in a compressed form and comprises a BIOS image file and hardware information such as memory addresses, block sizes, flash memory formats, and erase and write functions of different kind flashed memory. In step S43, whether a flash memory on a motherboard is supported or listed in the hardware information is checked. If so, in step S44, capacity of the flash memory is then freed by the erase function. The computer system completes the BIOS updating procedure by copying the BIOS image file from the system memory to the flash memory according to the flash memory format obtained, as shown in step S45.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for updating a BIOS image file, comprising the following steps:
loading an operating system into a system memory;
providing a compressed data file comprising hardware information and a BIOS image file, wherein the hard information comprises erase functions and flash memory formats of various kind flash memories;
executing a BIOS update program to decompress the compressed data file and to store the hardware information and the BIOS image file into the system memory at the same time;
erasing the flash memory using a retrieved erase function in the hardware information; and
writing the BIOS image file in the system memory to the flash memory.

2. The method for updating a BIOS image file as claimed in claim 1, wherein the operating system is loaded from a peripheral storage device.

3. The method for updating a BIOS image file as claimed in claim 1, wherein the compressed data file is provided from a peripheral storage device.

4. The method for updating a BIOS image file as claimed in claim 2, wherein the peripheral storage device provides at least one boot function.

5. The method for updating a BIOS image file as claimed in claim 1, wherein the system memory is dynamic random access memory (DRAM).

6. The method for updating a BIOS image file as claimed in claim 1, wherein the hardware information further comprises write functions and address information of various kind flash memories.

7. A method for updating a BIOS image file for a computer system comprising a system memory and a flash memory, the method comprising the following steps:
providing a peripheral storage device storing compressed data information, wherein the compressed data information comprises first information and a BIOS image file;
loading an operating system into the system memory;
decompressing the compressed information and storing the first information and the BIOS image file into the system memory, the first information comprising a flash memory format and an erase function corresponding to the flash memory;
erasing the flash memory according to the erase function in the system memory; and
writing the BIOS image file in the system memory to the flash memory according to the flash memory format.

8. The method for updating a BIOS image file as claimed in claim 7, wherein the peripheral storage device comprises an operating system.

9. The method for updating a BIOS image file as claimed in claim 7, wherein the system memory is dynamic random access memory (DRAM).

10. The method for updating a BIOS image file as claimed in claim 7, wherein the peripheral storage device provides at least one boot function.

11. The method for updating a BIOS image file as claimed in claim 7, wherein the hardware information further comprises write functions and address information of various kind flash memories.
